(19) United States
(12) Patent Application Publication
(10) Pub. No.: US 2026/0320540 A1
(43) Pub. Date: Oct. 15, 2026

(54) Generating Geographic Coordinate Data For An Object In Transit Based On Waypoint Data Received From A Computer-Based Tracking System Using A Coordinate Data Model

(71) Applicant: Shopify Inc., San Francisco, CA (US)

(72) Inventor: Michael Schneider, Ottawa (CA)

(21) Appl. No.: 19/467,532

(22) Filed: Feb. 2, 2026

Related U.S. Application Data
(63) Continuation of application No. 17/160,792, filed on Jan. 28, 2021, now abandoned.

(51) Int. Cl. G06Q 10/0833; G06F 16/29; G06Q 10/083

(52) U.S. Cl. CPC G06Q 10/0833; G06F 16/29; G06Q 10/0838

(57) ABSTRACT

A tracking identifier associated with a particular object in transit is transmitted to a computer-based tracking system via a network using an application programming interface (API). An estimated geographic coordinate associated with the location of the particular object is determined based on: the location of the particular object as indicated in the response from the API, an amount of time that has elapsed since the particular object has left the location of the particular object as indicated in the response from the API, and an expected travel time between the location of the particular object as indicated in the response from the API and an estimated next location of the particular object. The estimated geographic coordinate is determined using a geographic coordinate model. Output based on the estimated geographic coordinate is provided to a computer device via the network.

### FIELD

The present application relates to determining locations of objects in transit, and particularly determining geographic coordinates associated with waypoint data using a coordinate data model.

### BACKGROUND

A carrier may implement a computer-based package tracking system, with each package being assigned a different tracking identifier that uniquely identifies that package in the package tracking system. A shipping status is stored in association with the tracking identifier. The shipping status provides a status of where the package is in the shipping process, e.g. the location of the package.

The tracking identifier may be encoded in a machine-readable code, such as a barcode or QR code. The machine-readable code is typically included on the shipping label affixed to the outside of the package. Whenever a shipping event occurs during the shipping process, e.g. the package arrives at or leaves a waypoint, the machine-readable code may be read by a device at the event location and the shipping status is updated.

The tracking identifier may be used by another computer system to make a request (“call”) to an application programming interface (API) of the carrier's package tracking system. The carrier's API returns the shipping status for the package associated with that tracking identifier. The shipping status may then be used by the computer system, e.g. the shipping status may be provided for display at a user interface of the buyer's device.

### SUMMARY

When a computer system uses a tracking identifier to make an API call to an API of a carrier's package tracking system, the shipping status returned from the API might have the technical drawback of not being precise enough to be used in a way intended for the computer system.

As one example, the computer system may be configured to generate web content in the form of a visual display that shows the location of the package on a map. An API call may be made for a package that originated in Brazil and that is destined for New York City. The API call may return the current location of the package as “Florida”. Florida covers a relatively large geographical area and does not provide a precise location for display on the map. The current package location may need to be shown on the map as a circle encompassing all of Florida, which is neither precise nor informative. Alternatively, the map might display the package as located at a representative point in Florida, e.g. Tallahassee, the state capital of Florida. However, if the package is actually in a depot in Miami, then indicating that the package is in Tallahassee is inaccurate.

As another example, a precise yet relatively accurate location of the package may be needed by the computer system to implement important actions such as: updating a shipping tracking model (e.g. performing adaptive training of a machine learning model), and/or predicting a shipping delay, and/or updating an estimated time of arrival of the package, and/or estimating the carbon emissions associated with shipping the package, and/or generating a visualization of the package route, etc.

Systems and methods are disclosed in some embodiments which an indication of a package's location, received from an API of a carrier, is used to generate a more precise location that aims to more accurately represent the actual location of the package. For example, the location “Florida” returned from the carrier's API may be used to generate latitude/longitude coordinate (25.774, −80.193). The coordinate (25.774, −80.193) is not just any coordinate in Florida, but is one that aims to more accurately represent the actual location of the package. For example, the coordinate may be the location of a depot near a port in Miami. In some embodiments, the coordinate is determined using both the general location returned from the API and information associated with the shipping of the package, e.g. a previous shipping event for the package and/or the carrier used to carry the package, etc.

In some embodiments, the coordinate may form the basis of web content that is ultimately presented at a user interface. As one example, web content may be generated in the form of a map showing a circle centered around the coordinate (25.774, −80.193), which is meant to represent the location of the package on the map.

In an embodiment, there is provided a computer-implemented method. The method includes a step of transmitting, to a computing interface provided by a carrier, a tracking identifier associated with a package being shipped. The method then involves receiving, from the computing interface, a response indicating a location of the package, and generating a geographic coordinate associated with the location of the package based on: (i) the location of the package as indicated in the response from the computing interface, and (ii) information associated with shipping of the package. The computer-implemented method may further include a step of providing output based on the geographic coordinate.

In some embodiments, the information associated with the shipping of the package may include an indication of one or more prior locations of the package. In some embodiments, the geographic coordinate may be generated using the location of the package as indicated in the response from the computing interface and the indication of the one or more prior locations of the package. In some embodiments, the information associated with the shipping of the package may include an indication of a time at which the package was present at one of the one or more prior locations. In some embodiments, the geographic coordinate may also be generated using the indication of the time. In some embodiments, the information associated with the shipping of the package may include at least one of: a carrier, a service class, one or more prior locations of the package, a date/time stamp associated with a prior location of the package, an estimated next location of the package, a method of transportation of the package, or a known location of a waypoint.

In some embodiments, generating the geographic coordinate may include calculating an estimated location of the package based on: the location of the package as indicated in the response from the computing interface, and/or an amount of time that has elapsed since the package has left the location of the package as indicated in the response from the computing interface, and/or an expected travel time between the location of the package as indicated in the response from the computing interface and an estimated next location of the package.

In some embodiments, the geographic coordinate may represent a centroid of latitude and longitude coordinates of two or more known locations. The two or more known locations may each be determined using: (i) the location of the package as indicated in the response from the computing interface, and/or (ii) the information associated with the shipping of the package. In some embodiments, the centroid may be a weighted average of the latitude and longitude coordinates of the two or more known locations. In some embodiments, a weighting may be determined based on a likelihood that the package is located at a particular one of the two or more known locations. In some embodiments, the two or more known locations may each be a location of a respective different waypoint.

In some embodiments, the output maybe web content. In some such embodiments, the web content may include instructions to present a visualization on a display of a user device. In some embodiments, the visualization may include a map with a visual indication at or around the geographic coordinate.

In some embodiments, the geographic coordinate may be used for at least one of: displaying the location of the package on a map, updating a tracking model, predicting a shipping delay, updating an estimated time of arrival of the package, or estimating carbon emissions associated with the package.

In some embodiments, the geographic coordinate may be generated using a model that incorporates the information associated with the shipping of the package. In some embodiments, the method may further include receiving, from a tracking unit, an indication of a latitude and longitude coordinate associated with a waypoint. In some embodiments, the method may further include updating the model based on the latitude and longitude coordinate associated with the waypoint.

A system is also disclosed that is configured to perform the methods disclosed herein. For example, the system may include at least one processor to directly perform (or instruct the system to perform) the method steps.

In another embodiment, there is provided a computer readable medium having stored thereon computer-executable instructions that, when executed by a computer, cause the computer to perform operations of the methods disclosed herein.

### BRIEF DESCRIPTION OF THE DRAWINGS

Embodiments will be described, by way of example only, with reference to the accompanying figures wherein:

FIG. 1 is a block diagram of an e-commerce platform, according to one embodiment;

FIG. 2 illustrates a home page of an administrator, according to one embodiment;

FIG. 3 illustrates the e-commerce platform of FIG. 1, but with a memory and a geographic coordinate generator;

FIG. 4 illustrates a system for generating a geographic coordinate associated with a package being shipped, according to one embodiment;

FIG. 5 illustrates an example of a shipping record for a package being shipped, according to one embodiment;

FIGS. 6 and 7 illustrate examples of models stored in memory used to generate the precise location of a package being shipped, according to some embodiments;

FIGS. 8 to 11 illustrate example user interfaces providing a user with a more precise location of a package being shipped, according to some embodiments; and

FIG. 12 illustrates steps of a computer-implemented method, according to one embodiment.

### DETAILED DESCRIPTION

For illustrative purposes, specific example embodiments will now be explained in greater detail below in conjunction with the figures.

### Example e-Commerce Platform

In some embodiments, the methods disclosed herein may be performed on or in relation to a commerce platform, which will be referred to herein as an e-commerce platform. Therefore, for completeness, an example of an e-commerce platform will first be described.

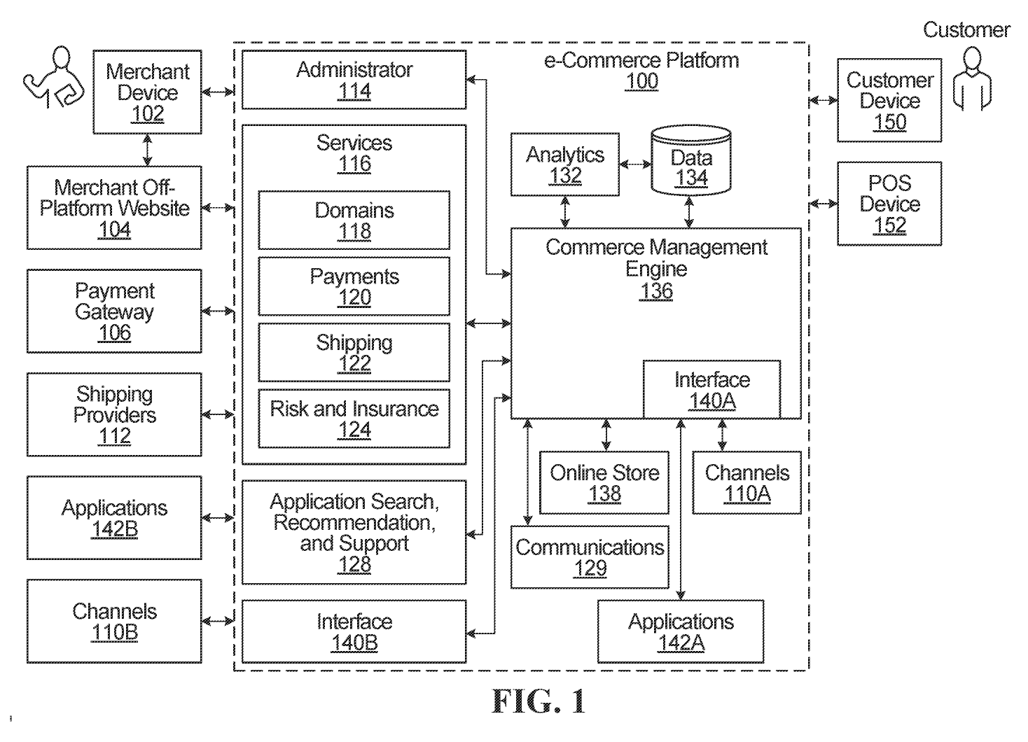

FIG. 1 illustrates an e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

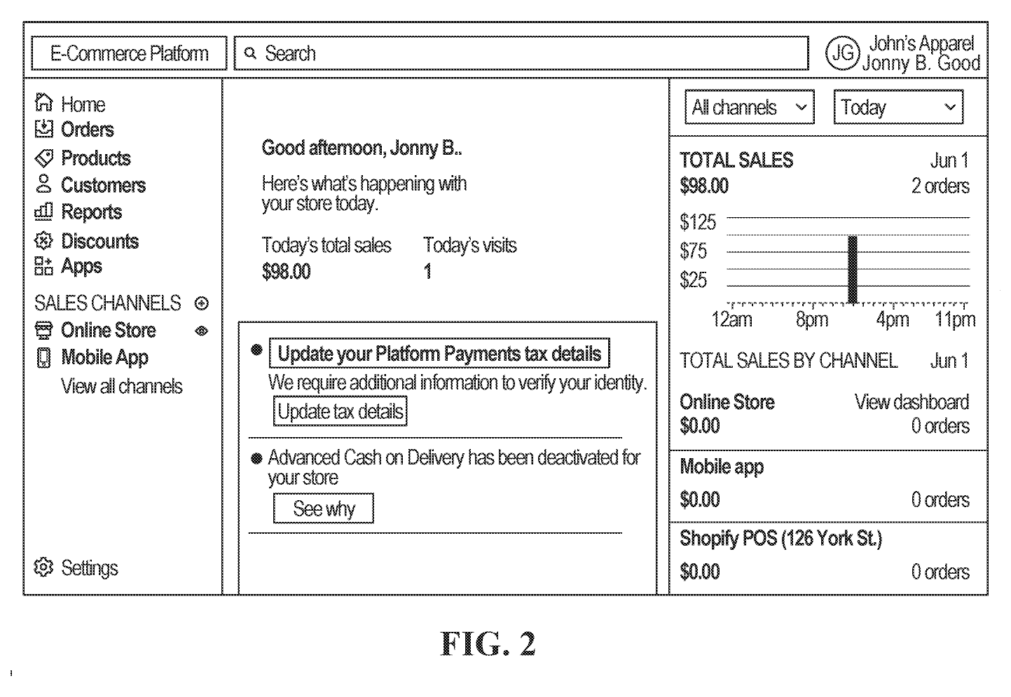

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's bank account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the platform 100 or by a different party. In some embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partners-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Generating Geographic Coordinates in the e-Commerce Platform 100

A customer may purchase a product from a merchant's online store 138, which may then be shipped to the customer. The customer and/or e-commerce platform 100 may wish to know the location of the package being shipped while the package is in transit. However, the API associated with the carrier of the package being shipped may not provide a precise location in response to an API call. For instance, a package may be shipped from Rio de Janeiro to New York, and the API call may return the location “Florida” while the package is in transit. As the state of Florida is a large area, a more precise location may be desirable for the customer to understand where their package is located, and/or to provide an estimated arrival time, and/or to predict a shipping delay, and/or to estimate the carbon emissions associated with shipping the package, and/or to visualize the shipping route of an order, and/or to update a mathematical model.

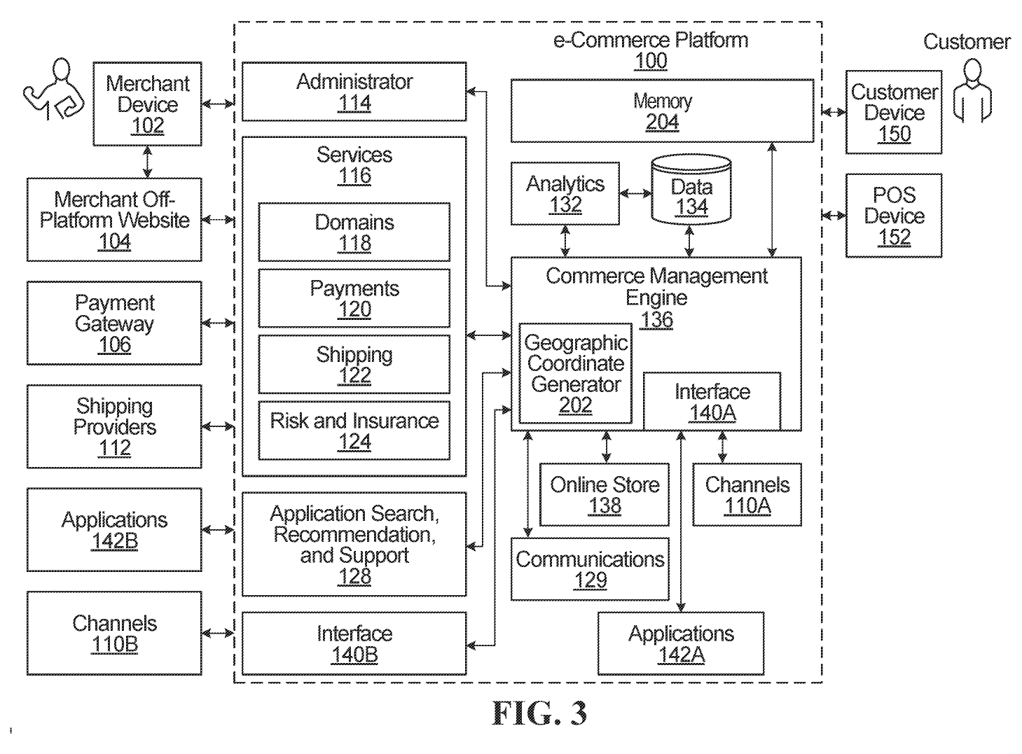

FIG. 3 illustrates the e-commerce platform 100 of FIG. 1, but with the additions of a geographic coordinate generator 202 and a memory 204. The geographic coordinate generator 202 may be embodied as part of the commerce management engine 136. The geographic coordinate generator 202 performs the geographic coordinate generating methods disclosed herein. For example, the geographic coordinate generator 202 may generate a geographic coordinate associated with a location of a package being shipped, e.g. via a geographic coordinate model in the manner described herein. The geographic coordinate model 202 may also provide output based on the generated geographic coordinate, e.g. as described herein. The geographic coordinate generator 202 may be implemented by one or more general-purpose processors that execute instructions stored in a memory (e.g. in memory 204) or stored in another non-transitory computer-readable medium. The instructions, when executed, cause the geographic coordinate generator 202 to perform the operations of the geographic coordinate generator 202, e.g., operations relating to the generation of a geographic coordinate for a package being shipped to a customer of a merchant's online store 138. Alternatively, some or all of the geographic coordinate generator 202 may be implemented using dedicated circuitry, such as an application specific integrated circuit (ASIC), a graphics processing unit (GPU), or a programmed field programmable gate array (FPGA). In some embodiments, the geographic coordinate generator 202 may be located inside the e-commerce platform 100 but external to, and coupled to, the commerce management engine 136. In some embodiments, the geographic coordinate generator 202 may instead be located externally to the e-commerce platform 100 and possibly coupled to the commerce management engine 136.

The memory 204 of the e-commerce platform 100 of FIG. 3 may contain data in the form of shipping records, which may be used to provide information about a package being shipped, and geographic coordinate models used by the geographic coordinate generator 202 in the manner described herein. In some embodiments, the memory 204 may be part of the geographic coordinate generator 202.

Although the embodiments described herein may be implemented using the geographic coordinate generator 202 in e-commerce platform 100, the embodiments are not limited to the specific e-commerce platform 100 of FIGS. 1 to 3 and could be used in connection with any e-commerce platform. Also, the embodiments described herein need not necessarily be implemented in association with an e-commerce platform, but might instead be implemented as a standalone component or service. Therefore, the embodiments below will be described more generally.

### Example System for Generating Geographic Coordinates

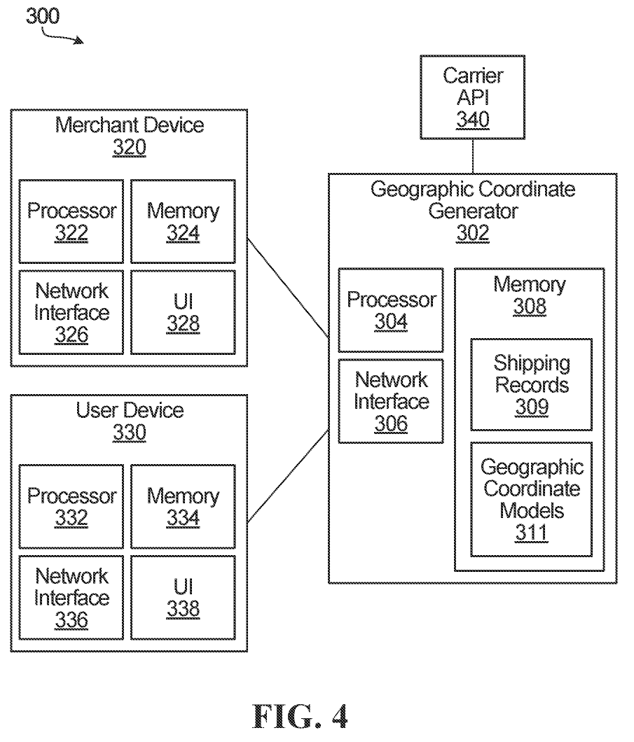

FIG. 4 illustrates a system 300 for determining a geographic coordinate associated with a package being shipped, according to one embodiment. The system 300 includes a geographic coordinate generator 302, at least one merchant device 320, at least one user device 330, and at least one carrier API 340. Only a single merchant device 320, a single user device 330, and a single carrier API 340 are illustrated.

The geographic coordinate generator 302 may be a part of an e-commerce platform, e.g. e-commerce platform 100. The geographic coordinate generator 302 of system 300 includes a processor 304, a network interface 306, and a memory 308. The processor 304 directly performs, or instructs the geographic coordinate generator 302 to perform, the operations described herein of the geographic coordinate generator 302, e.g., operations such as transmitting a tracking identifier associated with a package being shipped to a carrier API 340, computing a geographic coordinate based on the response from the carrier API 340, etc. The processor 304 may be implemented by one or more general purpose processors that execute instructions stored in a memory (e.g. in memory 308) or stored in another computer-readable medium. The instructions, when executed, cause the processor 304 to directly perform, or instruct the geographic coordinate generator 302 to perform the operations described herein. In other embodiments, the processor 304 may be implemented using dedicated circuitry, such as a programmed FPGA, a GPU, or an ASIC.

The network interface 306 is for communicating over a network, e.g. to communicate with merchant device 320 and/or user device 330 and/or carrier API 340 described below. The network interface 306 may be implemented as a network interface card (NIC), and/or a computer port (e.g. a physical outlet to which a plug or cable connects), and/or a network socket, etc., depending upon the implementation.

The geographic coordinate generator 302 further includes a memory 308. A single memory 308 is illustrated in FIG. 4, but in implementation the memory 308 may be distributed. The memory 308 may include shipping records 309 and geographic coordinate models 311, which will be described in more detail later. For ease of explanation, the reference character 309 will also be used when referring to a single shipping record 309 within the shipping records 309, and the reference character 311 will also be used when referring to a single geographic coordinate model 311 within the geographic coordinate models 311.

In some embodiments, the geographic coordinate generator 302 may be implemented inside of an e-commerce platform, e.g. inside e-commerce platform 100. In some embodiments, the processor 304, memory 308, and/or network interface 306 may be located outside of the geographic coordinate generator 302.

A plurality of merchants may communicate with (e.g. access) the geographic coordinate generator 302 over a network using merchant devices. For example, a merchant may input information relating to a package, e.g. the carrier or the origin location, using merchant device 320. The merchant device 320 may be a mobile device (e.g. a smartphone, laptop, tablet), a desktop computer, an augmented reality (AR) device, etc., depending upon the implementation. For ease of explanation, only a single merchant device 320 is illustrated in FIG. 4. The merchant device 320 includes a processor 322, a memory 324, a user interface 328, and a network interface 326. The processor 322 directly performs, or instructs the merchant device 320 to perform, the operations of the merchant device 320 described herein, e.g. enabling the merchant to enter, via the use of user interface 328, a geographic location associated with the origin location of a package being shipped by the merchant. The processor 322 may be implemented by one or more general-purpose processors that execute instructions stored in a memory (e.g. memory 324) or stored in another computer-readable medium. The instructions, when executed, cause the processor 322 to directly perform, or instruct the merchant device 320 to perform, the operations described herein. In other embodiments, the processor 322 may be implemented using dedicated circuitry, such as a programmed FPGA, a GPU, or an ASIC.

The user interface 328 may be implemented as a display screen (which may be a touch screen), and/or a keyboard, and/or a mouse, etc., depending upon the implementation. The network interface 326 is for communicating with the geographic coordinate generator 302 over the network. The structure of the network interface 326 will depend on how the merchant device 320 interfaces with the network. For example, if the merchant device 320 is a mobile phone, laptop, or tablet, the network interface 326 may comprise a transmitter/receiver with an antenna to send and receive wireless transmissions to/from the network. If the merchant device 320 is a personal computer connected to the network with a network cable, the network interface 326 may comprise a NIC, and/or a computer port (e.g. a physical outlet to which a plug or cable connects), and/or a network socket, etc.

A plurality of users may access the geographic coordinate generator 302 over a network using user devices, e.g. to be provided geographic coordinates associated with the location of packages being shipped, and/or to be provided content based on or incorporating the geographic coordinates (e.g. web content in a form of a map showing the location of a package). For ease of explanation, only a single user device 330 is illustrated in FIG. 4. The user device 330 may be a mobile device (e.g. a smartphone, laptop, tablet), a desktop computer, an AR device, etc., depending upon the implementation. The user device 330 includes a processor 332, a memory 334, a user interface 338, and a network interface 336. The processor 332 directly performs, or instructs the user device 330 to perform, the operations of the user device 330 described herein, e.g. providing, through the use of a map on user interface 338, geographic coordinates indicative of the location of a package being shipped to the user. The processor 332 may be implemented by one or more general purpose processors that execute instructions stored in a memory (e.g. memory 334) or stored in another non-transitory computer-readable medium. The instructions, when executed, cause the processor 332 to directly perform, or instruct the user device 330 to perform, the operations described herein. In other embodiments, the processor 332 may be implemented using dedicated circuitry, such as a programmed FPGA, a GPU, or an ASIC.

The user interface 338 may be implemented as a display screen (which may be a touch screen), and/or a keyboard, and/or a mouse, etc., depending upon the implementation. The network interface 336 is for communicating with the geographic coordinate generator 302 over the network. The structure of the network interface 336 will depend on how the user device 330 interfaces with the network. For example, if the user device 330 is a mobile phone, laptop, or tablet, the network interface 336 may comprise a transmitter/receiver with an antenna to send and receive wireless transmissions to/from the network. If the user device 330 is a personal computer connected to the network with a network cable, the network interface 336 may comprise a NIC, and/or a computer port (e.g. a physical outlet to which a plug or cable connects), and/or a network socket, etc.

The geographic coordinate generator 302 also communicates over the network with one or more carrier APIs. For ease of explanation, only a single carrier API 340 is illustrated in FIG. 4. Carrier API 340 is the API belonging to a carrier used by one or more merchants to ship their packages to customers. The geographic coordinate generator 302 may make requests to the carrier API 340 when the geographic coordinate generator 302 is generating a geographic coordinate to determine the location of a package being shipped, as described in more detail later.

In some embodiments, the geographic coordinate generator 302 is part of an e-commerce platform, e.g. e-commerce platform 100. For example, the geographic coordinate generator 302 may be geographic coordinate generator 202 illustrated in FIG. 3. However, this is not necessary. The geographic coordinate generator 302 may, for example, instead be provided by another component of an e-commerce platform or implemented as a stand-alone component or service that is external to an e-commerce platform. In some embodiments, either or both of the applications 142A-B of FIG. 3 provide the geographic coordinate generator 302 in the form of a downloadable application that is available for installation, e.g. in relation to a customer and/or merchant account. In other embodiments, the geographic coordinate generator 302 may be implemented on or in association with a computer system that is not an e-commerce platform. In some embodiments, some operations of the geographic coordinate generator 302 described herein could potentially be implemented in part on/by merchant device 320 and/or user device 330.

### Generating a Geographic Coordinate

Information associated with the shipping of a package is known. At least some of this information may be used in the manner described herein in order to determine a geographic coordinate from a general location returned from a carrier API 340. A geographic coordinate may be a latitude/longitude coordinate. Information associated with the shipping of a package that may be used to determine a geographic coordinate may include at least one of the following: a carrier, a service class, a method of transportation, previous locations of the package, date/time stamps associated with the previous locations of the package, an estimated next location of the package, known locations of waypoints, or the origin and/or delivery address of the package. It is to be noted that the list of information that may be used to determine a geographic coordinate of a package being shipped just given is not an exhaustive list, and other types of information may be used instead or in addition to the listed, example types of information.

In some embodiments, knowledge of the carrier shipping the package may be used to determine a geographic coordinate of a package being shipped. The carrier may be known from the tracking identifier. For example, a tracking identifier may uniquely map to a particular carrier. As another example, the carrier may have been indicated by the merchant via the user interface 328 of merchant device 320. For example, if the merchant uses e-commerce platform 100 or other application, such as geographic coordinate generator 302, to connect with and select a carrier, such as to connect with the carrier having carrier API 340, then once the carrier is selected the identity of the carrier is known and may be stored, e.g. as part of a shipping record 309.

In some embodiments, the service class may be used to determine a geographic coordinate. Service class is sometimes alternatively referred to as “mail class” (though the use of the postal service for delivery is by no means necessarily implied or required) and refers to the level of service assigned to delivery of the package, e.g. expedited shipping vs. regular priority shipping, etc. The service class may be known from the tracking identifier. For example, a tracking identifier may uniquely map to a particular service class. As another example, the service class may be known because a specific service class was selected at checkout. As another example, the service class may be deduced from past shipping records for the carrier, such as from the shipping records 309 that correspond to the carrier that are stored in the memory 308 of the geographic coordinate generator 302. For instance, in the past Carrier A always used expedited shipping for packages within a certain weight category and/or for packages that carry items having a purchase price above a certain amount.

In some embodiments, the previous locations of the package and possibly associated date/time stamps may be used to determine a geographic coordinate. For example, the carrier API 340 may return an indication of the previous locations at which the package has been scanned during the trip thus far, e.g. in the form of a partially completed shipping record, such as a shipping record 309 stored in the memory 308.

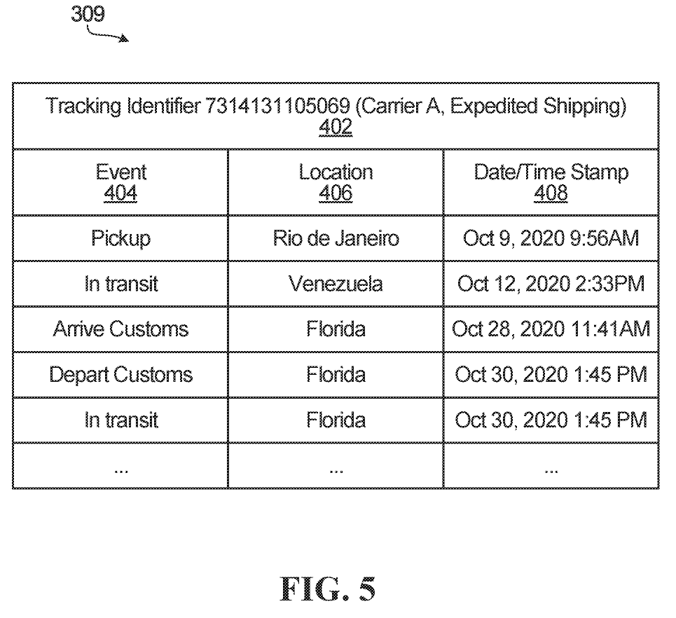

FIG. 5 illustrates an example of a shipping record for a package being shipped, according to one embodiment. The shipping record 309 stored in memory 308 of geographic coordinate generator 302 provides a partially completed shipping record of the package being shipped from Rio de Janeiro to New York, in which the package is in transit in Florida. The shipping record 309 is associated with a tracking identifier 402 having an identifier number, a carrier, and a service class. For instance, tracking identifier 402 of shipping record 309 is “7314131105069”, associated with Carrier A and service class “Expedited Shipping”. Rows of the shipping record 309 provide information associated with each shipping event of the package, which may be provided from the carrier API 340 in response to the API calls made by the geographic coordinate generator 302. Columns of the shipping record 309 include information relating to a type of shipping event 404, a location at which the shipping event occurs 406, and a date/time stamp 408 associated with the shipping event. For example, the first entry in the shipping record 309 is the event 404 “Pickup” of the package at the location 406 of “Rio de Janeiro” with a date/time stamp 408 of “Oct. 9, 2020 9:56 AM”.

In some embodiments, the estimated next location of the package may be used to determine a geographic coordinate. For example, based on a model for the carrier built from previous shipping records, such as a geographic coordinate model 311 stored in the memory 308 of the geographic coordinate generator 302, it may be determined that all packages in a particular weight category and service class for a particular carrier, which travel through Florida, and which are ultimately destined for New York state, always arrive next in Atlanta, Ga. on average twelve hours after leaving the waypoint location in Florida.

In some embodiments, the known location of waypoints may be used to determine a geographic coordinate. A waypoint may be a depot or another intermediate point through which a package being shipped may travel through. A known waypoint might be specific to a carrier, e.g. the address of the depot for Carrier A in Miami is 123 Main Street Miami, Fla. 31192. Alternatively, a waypoint might not be specific to a carrier and/or might be represented by the centroid of multiple locations, e.g. all known carrier depots in Miami are in a same neighborhood surrounding a particular port, and an average latitude/longitude location (i.e., the centroid) of the depots is (25.774, −80.193). The known location of the waypoint may be stored as part of the geographic coordinate model 311 in the memory 308 of the geographic coordinate generator 302.

In some embodiments, the origin and/or delivery address of the package may be used to determine a geographic coordinate. The origin address may be known based on the information provided by a merchant, e.g. the origin address may be provided to geographic coordinate generator 302 via the user interface 328 of merchant device 320. The delivery address may be confirmed at checkout, and may be input by a customer via the user interface 338 of user device 330, which then may be provided to the geographic coordinate generator 302.

In some embodiments, the method of transportation may be used to determine a geographic coordinate. The method of transportation may be known based on the origin and destination locations, the carrier, the service class of the package being shipped, and/or previous locations of the package and associated date/time stamps. This method of transportation of the package being shipped may be inferred based on other known information and perhaps the geographic coordinate model 311 stored in the memory 308 of the geographic coordinate generator 302, as described herein.

In some embodiments, a model, e.g. a geographic coordinate model 311, may be built using previous shipping records, such as the shipping records 309 stored in the memory 308, and information that is associated with or deduced from the previous shipping records. The model may be built in advance (in non-real time) and then used in real-time (or near-real time) to determine a more precise coordinate from a general location returned by a carrier's API, such as carrier API 340. The model 311 may be specific to a carrier and/or service class and/or time of year and/or merchant, etc.

As one example, geographic coordinate generator 302 may have access to many shipping records 309 for products previously purchased by users and sold by merchants associated with geographic coordinate generator 302 and shipped by Carrier A. A review of the past shipping records 309 for Carrier A, as well as a review of known information about Carrier A, may reveal that: regardless of weight of the package, for any package of regular service class, having an origin address in South America and a delivery address in North-Eastern U.S.A., the package always arrives by boat from Venezuela to Miami and then travels by vehicle to Atlanta an average of 12 hours after clearing customs in Miami.

Arrival by boat from Venezuela may be deduced using the past shipping records 309 for Carrier A by noting the average time it takes a package to travel from Venezuela to Florida. Arrival specifically in Miami (rather than in another city in Florida) may be determined using out-of-band knowledge, e.g. it may be known from a public source that the only port of entry and customs processing center in Florida for arrival from South America is in Miami. It might also be known (e.g. from a public source) that there are three possible customs processing centers that clear incoming goods from boats in Miami, respectively located at latitude/longitude coordinates (25.783, −80.190), (25.768, −80.190), and (25.772, −80.200). Arrival in Atlanta 12 hours after clearing customs may be deduced from the past shipping records 309 for Carrier A. Travel by vehicle to Atlanta may be deduced based on the average time of 12 hours, and the fact that the distance between Miami and Atlanta over land is not that far, such that plane may be unnecessary.

The deductions above may be performed offline to generate a geographic coordinate model 311, which may be in the form of rules or a mapping stored in memory 308 (e.g. in the form of a look-up table) of the geographic coordinate generator 302. The geographic coordinate model 311 may alternatively be in the form of a machine learning model. For example, the observations/deductions may be used to train a machine learning algorithm, which is subsequently used to estimate/determine the precise location given an input of a general location from Carrier A's API 340. In some embodiments, training (or retraining/updating) the machine learning algorithm may require more precise data than a general location returned by an API. The precise location in the form of a geographical coordinate, generated in a manner disclosed herein, may possibly be used for the training/retraining/updating of a machine learning model.

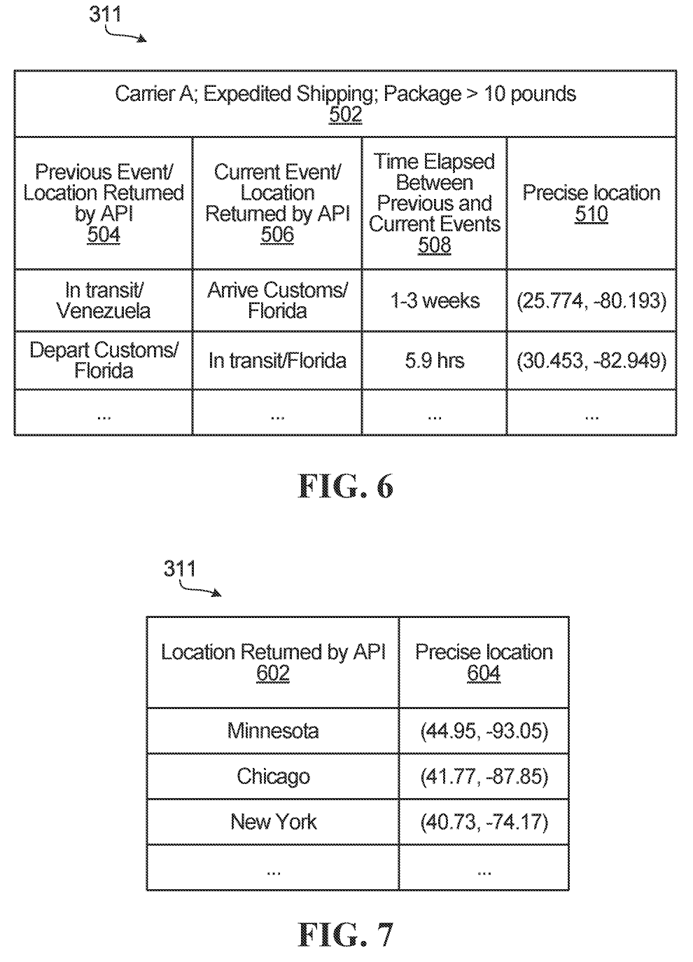

FIG. 6 illustrates an example of a geographic coordinate model 311 associated with Carrier A, according to one embodiment. Here, the geographic coordinate model 311 is a look-up table stored in memory 308 of the geographic coordinate generator 302, which shows precise locations of a package being shipped. The geographic coordinate model 311 includes information that may be used to determine a geographic coordinate for a package currently in transit and associated with the criteria 502 illustrated: the use of carrier “Carrier A”, the service class “Expedited Shipping”, and a package weight of less than 10 pounds. Each row in the geographic coordinate model 311 is indicative of a precise location 510 of a package being shipped when a particular response is returned to the geographic coordinate generator 302 from Carrier A's API 340. The columns of the geographic coordinate model 311 provide: a previous event/location returned by API 504, a current event/location returned by API 506, the amount of time that has elapsed between the API returning the previous and current locations 508, and a precise location of the package 510. For example, the first row in the look-up table of geographic model 311 indicates that when (i) the previous shipping event is the package being in transit from Venezuela, (ii) the current shipping event is the arrival of the package at customs in Florida, and (iii) one to three weeks have elapsed between the two shipping events, the precise location of the package is at the latitude/longitude coordinate (25.774, −80.193).

In the geographic coordinate model 311 of FIG. 6, the precise location in the first row, i.e. (25.774, −80.193), is (in this example) the centroid of three known customs processing centers that clear incoming goods from boats in Miami. The first customs processing center (“center X”) has a street address corresponding to (25.783, −80.190). The second customs processing center (“center Y”) has a street address corresponding to (25.768, −80.190). The third customs processing center (“center Z”) has a street address corresponding to (25.772, −80.200). Because the shipping event “arrival in customs—location Florida” does not reveal whether the package is in center X, Y, or Z, the precise location is selected as the centroid of the three coordinates:

(25.783, −80.190)+(25.768, −80.190)+(25.772, −80.200)/3=(25.774, −80.193).

In some embodiments, if packages belonging to a particular carrier and/or packages carrying a particular product category are known to more likely be processed by center X, then a weighting may be applied in the calculation of the centroid. For example, if it was known that 90% of the time a package weighing more than 30 pounds went to center X, then the precise location may be computed as:

[18*(25.783, −80.190)+(25.768, −80.190)+(25.772, −80.200)]/20=(25.782, −80.191).

In some embodiments, the coordinate of center X may just be used as the precise location, rather than calculating a centroid and applying a weighting, if it was known that center X was more likely to be the location at which the package was located.

Note that rather than a centroid calculation, a machine learning model may be used to output the precise location. The precise location output by the machine learning model might or might not be equal to the centroid. The embodiments herein in which a centroid is used are just examples.

In some embodiments, the look-up table of geographic coordinate model 311 of FIG. 6 might not include the actual precise location, but might instead set forth a rule for computing the precise location. For example, the precise location shown in the second row of the table, i.e. (30.453, −82.949), changes depending upon how much time has passed since the package departed customs in Miami. In the example, it is assumed that the time at which the precise location is being computed is 5.9 hours after the package left customs in Miami, in which case the package is assumed to be approximately halfway to Atlanta because it takes on average 12 hours for a package to travel from Miami to Atlanta. Therefore, a latitude/longitude coordinate halfway between Miami and Atlanta is computed, which in the example is (30.453, −82.949).

FIG. 7 illustrates an alternative example of a geographic coordinate model 311, according to another embodiment. This geographic coordinate model 311 stored in memory 308 in the geographic coordinate generator 302 may provide a precise location 604 corresponding to a location returned by an API 602. The geographic coordinate model 311 of FIG. 7 may be built offline, and it does not depend upon the history (e.g. previous shipping events/locations) of the package.

The geographic coordinate model 311 of FIG. 7 may be generated using known locations of waypoints (e.g. depots) of the carrier. For example, Carrier A may be known to only have one major depot in all of Minnesota, which is located at (44.95, −93.05). Therefore, if Carrier A's API 340 returns “Minnesota”, the general location “Minnesota” is mapped to the more precise coordinate (44.95, −93.05). As another example, Carrier A may be known to have three major depots in Chicago. Therefore, if Carrier A's API returns “Chicago”, the general location “Chicago” is mapped to the centroid of the three major depots, which in this example is the coordinate (41.77, −87.85).

In embodiments herein, a precise location in the form of a geographic coordinate is obtained based on both (i) the location of the package as indicated in the response from the carrier API 340, and (ii) information associated with shipping of the package. Because the precise location is determined based on information associated with the shipping of the package, it might be the case that two different packages generate two different precise locations, even if the two packages happen to have the same origin address and/or delivery address, and even if the general location returned from the carrier API 340 is the same for both packages. For example, assume two packages A and B are sent from London, UK to Pittsburgh, Pa., USA. An API call to the carrier API 340 for both packages returns the current location of each package as “New York City”. However, the past shipping information for package A indicates that the last event was leaving the UK three weeks ago, which corresponds to transit by boat. The location of the depot for receiving from boat in New York City is known to be (40.63, −74.19), and so this coordinate is used as a more precise location for package A. Meanwhile, the past shipping information for package B indicates that the last event was leaving the UK two days ago, which corresponds to transit by air. The depot for receiving from air in New York City is near the John F. Kennedy International Airport at location (40.65, −73.79), and so this coordinate is used as the more precise location for package B.

In some embodiments, the location of waypoints may be determined using public information, or may instead be determined by placing a tracking unit (e.g. a GPS tracking chip) on one or more packages and determining from the tracking unit the precise locations travelled by the package and the precise locations of the waypoints.

### Example Operation and User Interfaces

In operation, when the geographic coordinate generator 302 uses the tracking identifier to send an API call to a carrier API 340, a location of the package is returned from the API. Based on the location, as well as other information associated with the shipping of the package, a more precise geographic coordinate, such as a longitude/latitude coordinate, is generated, e.g. in the manner explained herein. The coordinate may then be used by the geographic coordinate generator 302 for different purposes, depending upon the implementation, e.g. displaying the location on a map, updating a tracking model, predicting a shipping delay, updating an estimated time of arrival of the package, and/or estimating the carbon emissions associated with shipping the package, etc.

In one example, the geographic coordinate is used to generate information to present on the user interface 338 of the user's device 330. For example, web content in the form of a visualization may be generated in which the package location is illustrated by an indicator on a map. The indicator might be a shape, e.g. a circle centered at the geographic coordinate. The size of the shape may be a function of the assumed accuracy of the coordinate. For example, if the coordinate is a centroid between multiple possible locations, the shape may cover an area around the centroid to convey the fact that the package location is not exactly known but is believed to be in or around the centroid, which is still a much smaller area than the more general location returned by the carrier API 340.

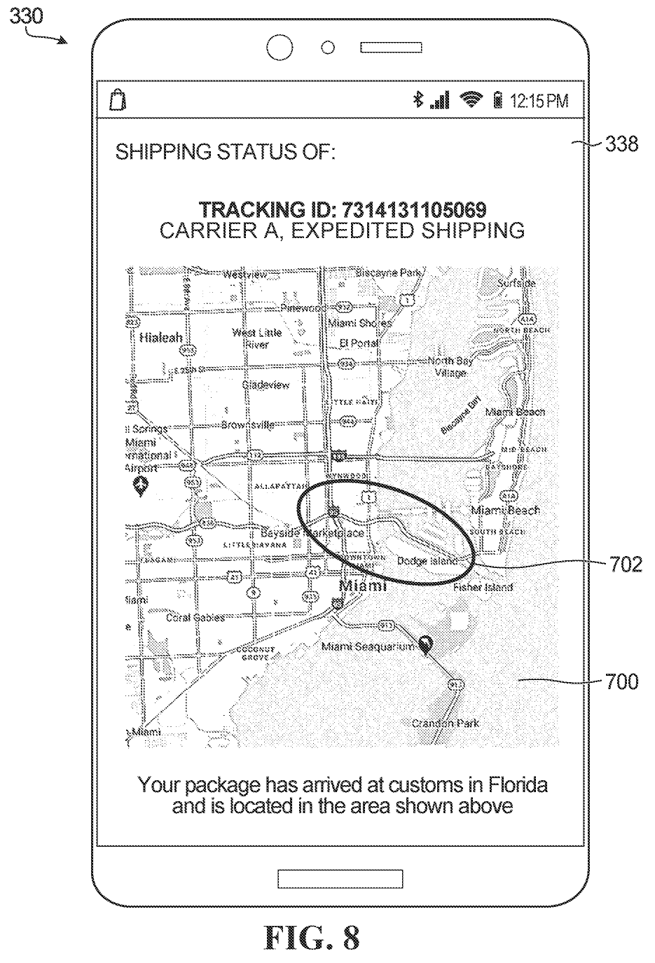

FIGS. 8 to 11 illustrate example user interfaces providing a user with a more precise location of a package being shipped, according to some embodiments. FIG. 8 provides a map 700 shown on the display of the user interface 338 of the user device 330. The map 700 is a map of the area corresponding to the location of the package being shipped. The map 700 also contains an indication 702 of the location, or the approximate location, of the package that has been generated by the geographic coordinate generator 302 based on a geographic coordinate. The geographic coordinate has been determined using a general location returned from an API call and a geographic coordinate model 311.

For example, user interface 338 is used to provide, to the user, the shipping status and a visualization of the location of the package having the tracking ID number “7314131105069”. The geographic coordinate generator 302 has requested the location of the package being shipped from the carrier API 340, which returned the location “Florida” and the most recent event as “Arrive Customs”, as shown in the shipping record 309 of FIG. 5. Based on this information, as well as the knowledge that the package's origin location is South America, the geographic coordinate model 311 of FIG. 6 is able to provide a more precise location of (25.774, −80.193), which is the centroid of three known customs processing centers that clear incoming goods from boats in Miami. The indicator 702 on map 700 shown on the user interface 338 is an oval centered at the latitude/longitude coordinate (25.774, −80.193) provided by the model 311. The oval also encompasses the coordinates of the three known customs processing centers.

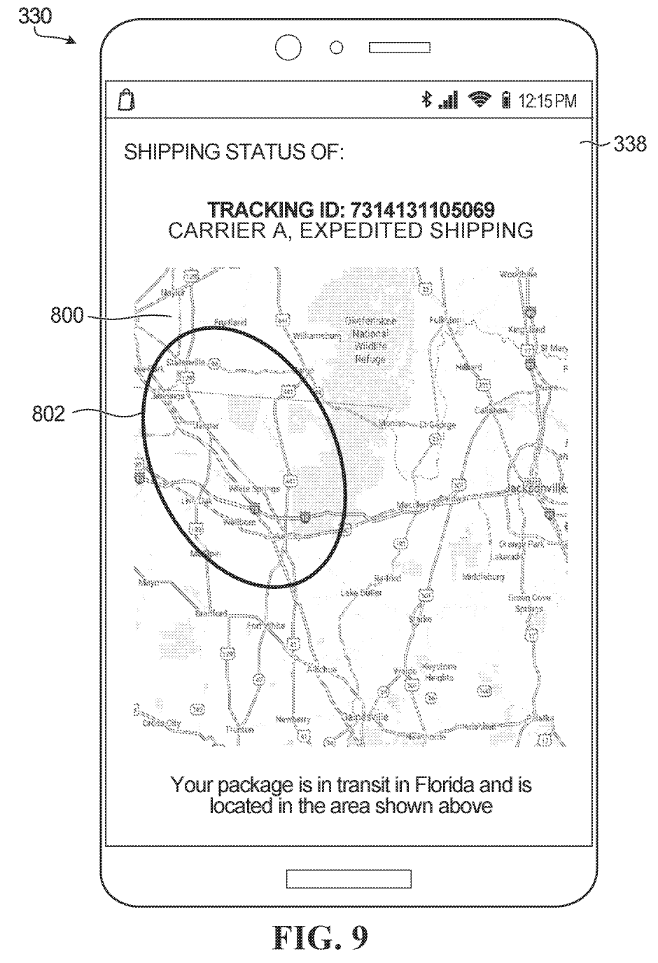

In another embodiment, FIG. 9 provides a map 800 shown on the display of the user interface 338 of the user device 330, which includes indicator 802 to show the user the location of the package being shipped. Like FIG. 8, FIG. 9 illustrates the location of the package having the tracking ID “7314131105069”. Here, the carrier API 340 returns, to the geographic coordinate generator 302, the location “Florida” and the most recent event as “In transit”. Based on this information, as well as the knowledge that the package has departed customs in Florida approximately six hours prior, the geographic coordinate model 311 of FIG. 6 is able to provide a more precise location of latitude/longitude coordinate (30.453, −82.949). The map 800 on the user interface 338 shows the general area, northern Florida, where the geographic coordinate generator 302 has determined the package to be located. As the package being shipped is in transit at not at a waypoint, the precise location is an estimate, and the indicator 802 is an oval encompassing an area through which the package may be travelling. The area encompassed by the oval of indicator 802 may be indicative of differences in the package's location, such as accounting for quickly or slowly moving traffic. The center of the oval may be at the latitude/longitude coordinate (30.453, −82.949).

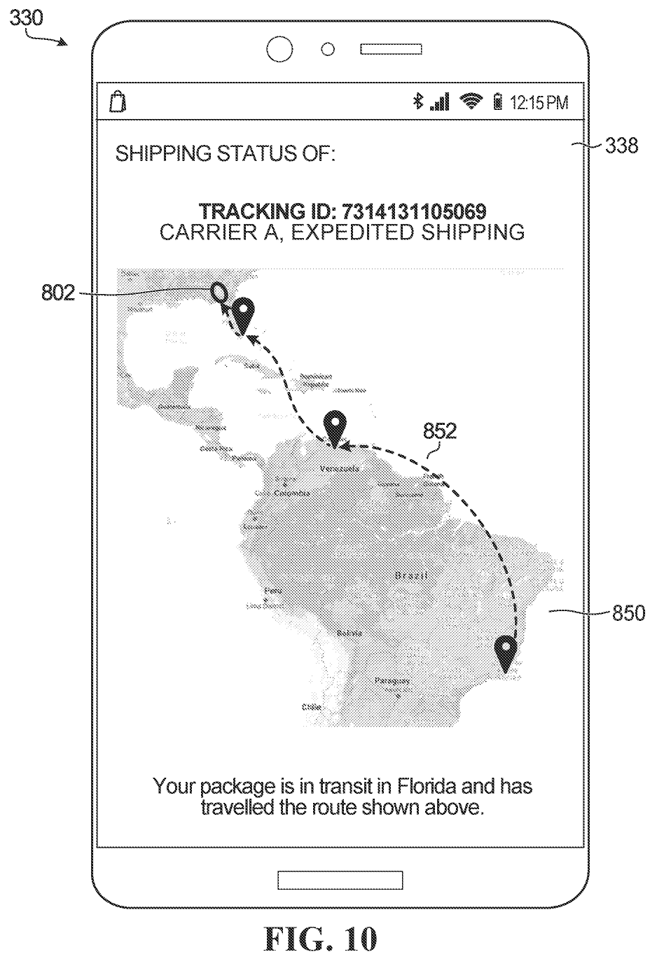

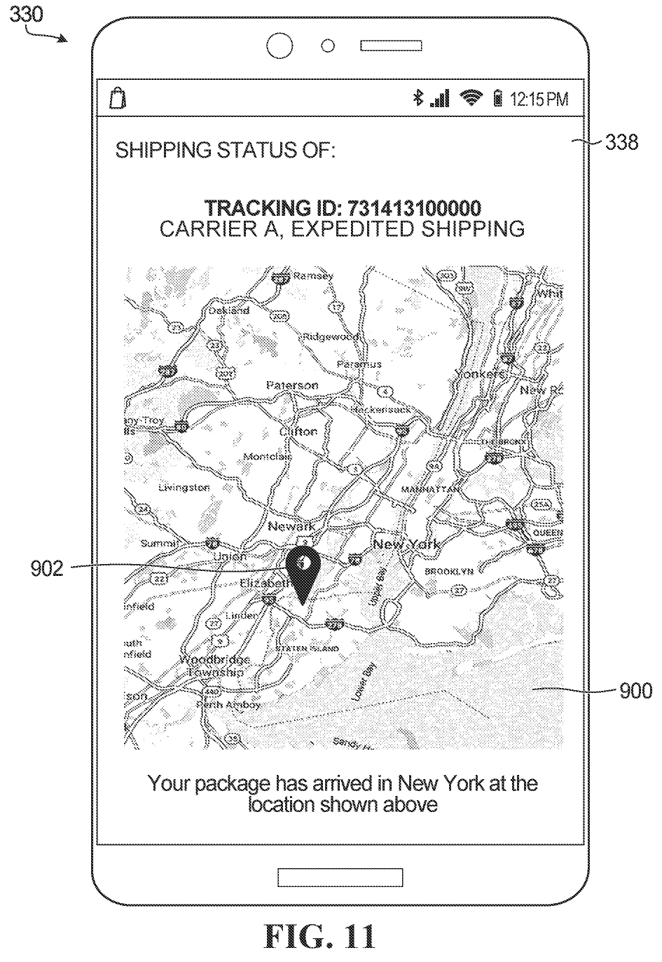

In another embodiment, FIG. 10 provides a map 850 shown on the display of the user interface 338 of the user device 330, which shows the route 852 that a package being shipped has travelled. Like FIGS. 8 and 9, FIG. 10 illustrates the location of the package having the tracking ID “7314131105069”. Here, the map 850 on the user interface 338 displays the route 852 the package being shipped has traveled based on the locations of the shipping events in shipping record 309 of FIG. 5, the subsequently predicted waypoints determined by the geographic coordinate model 311, and the method of transportation for each leg of the route determined by apriori knowledge or through inference by the geographic coordinate model 311. The route 852 on map 850 is provided by a series of indicators to mark waypoints and directional dashed lines to mark the likely route travelled. The route 852 shows that package originated in Rio de Janeiro, which is marked by an indicator as the first waypoint. A directional dashed arc links the indicator in Rio de Janeiro with a second indicator pointing at Venezuela, which is a second waypoint. The non-specific, high shape of the arc may indicate that the package has been transported by air. The route indicator in Venezuela is further linked to an indicator in Florida. This indicator in Florida is located at the port in Miami, as determined by the geographic coordinate model 311 shown in FIG. 6. As, for instance, the geographic coordinate model 311 may determine that the transport of the package between Venezuela and Miami may have been by boat, the path of route 852 is displayed on the map 850 as travelling through the Caribbean Sea between Hispaniola and Cuba. Since the map 850 of FIG. 10 displays the transit route 852 of the same package being shipped at the same point in time as the package being shipped in FIG. 9, the oval indicator 802 displaying the package's estimated location is displayed as part of the route 852. In another embodiment, FIG. 11 provides a map 900 shown on the display of the user interface 338 of the user device 330, which includes indicator 902 to show the user the location of the package being shipped. Here, the user interface 338 provides a visualization of the location of a package having a tracking ID “731413100000”, which is being shipped from London, UK to Pittsburgh, Pa., USA. A call to the carrier API 340 may have provided the geographic coordinate generator 302 with the information that the package has entered customs in New York City, N.Y., USA. The geographic coordinate model 311 stored in memory 308 of the geographic coordinate generator 302 may indicate that the package has arrived by boat based on the duration of time between shipment from London and arrival in New York City. The geographic coordinate model 311 may also contain information indicating that Carrier A uses a particular depot for receiving by boat in New York City located at the latitude/longitude coordinate (40.63, −74.19). The map 900 shows the port of New York City and the surrounding area, and the indicator 902 is a singular point located at the latitude/longitude coordinate (40.63, −74.19), as it is a particular known location.

### Example Methods

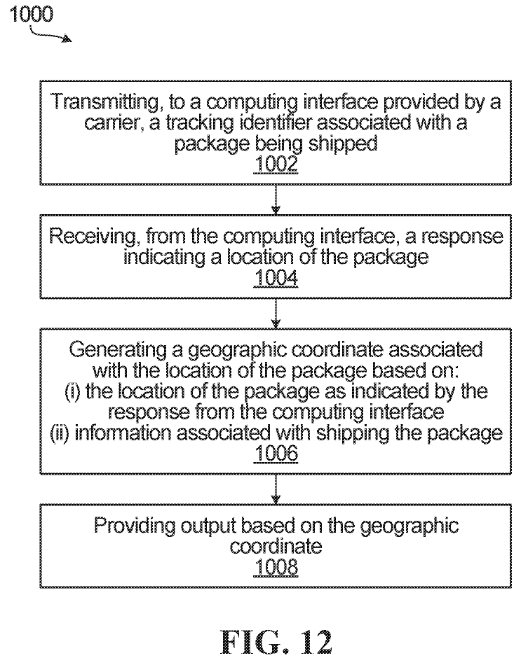

FIG. 12 illustrates a computer-implemented method 1000, according to one embodiment. Not all of the steps in the method 1000 of FIG. 12 are necessary in all embodiments. Also, some of the steps may be substituted by other steps instead. The method may be performed by or on an e-commerce platform, such as e-commerce platform 100, although this is not necessary. In method 1000, the steps are described as being performed by the processor 304 of geographic coordinate generator 302 of FIG. 4, but this is only an example. For example, the method 1000 may instead be performed by another entity, which might or might not be part of an e-commerce platform.

At step 1002 of method 1000, the processor 304 transmits, to a computing interface provided by a carrier, a tracking identifier associated with a package being shipped. An example of a computing interface is an API. For example, the processor 304 of the geographic coordinate generator 302 may make a call to the carrier API 340 in order to obtain a current location of the package. For example, the geographic coordinate generator 302 may transmit tracking identifier “7314131105069” 402 of the shipping record 309 of FIG. 5 to the carrier API 340.

At step 1004, the processor 304 receives, from the computing interface, a response indicating a location of the package. The processor 304 of geographic coordinate generator 302 may receive the response from carrier API 340, providing the location of the package being shipped. For example, the carrier API may return a response indicating that the package had arrived at customs in Florida on Oct. 28, 2020, 11:41 AM. This is illustrated by shipping record 309 of FIG. 5 stored in the memory 308 of the geographic coordinate generator 302.

At step 1006, the processor 304 generates a geographic coordinate associated with the location of the package based on: (i) the location of the package as indicated by the response from the computing interface and (ii) information associated with shipping the package. The geographic coordinate generator 302 generates a geographic coordinate indicative of a more precise location of the package being shipped. In some embodiments, the geographic coordinate is a latitude/longitude coordinate, however, this is just one example. A geographic coordinate could be any coordinate in 1D, 2D, or 3D that is indicative of a geographic location of the package. The geographic coordinate is generated based, in part, on the location of the package returned to the geographic coordinate generator 302 from the carrier API 340 received in step 1004 as well as other information associated with the package being shipped. Examples of other information associated with the shipping of the package are described earlier and may include the carrier, and/or the service class, and/or one or more previous locations of the package, and/or one or more known locations of waypoints, etc. This information may be incorporated into a geographic coordinate model 311 that may be used by the geographic coordinate generator 302 to generate the geographic coordinate.

For example, for the package having the tracking ID “7314131105069”, the API 340 may return “Arrive in Customs/Florida”, and the geographic coordinate may be determined to be latitude/longitude coordinate (25.774, −80.193). This coordinate is generated by coordinate generator 302 based on (i) the location returned from the carrier API 340, i.e. Florida, which is stored in the package's shipping record 311 of FIG. 5. As well, the coordinate is based on (ii) information, such as: the carrier, i.e. Carrier A; the service class, i.e. expedited shipping; and, the time elapsed between the previous event and the current event, which may be indicative of the mode of transportation used to ship the package. Using both (i) and (ii), the geographic coordinate generator 302 may be able to generate the coordinate (25.774, −80.193) using geographic coordinate model 311 of FIG. 6 stored in its memory 308.

At step 1008, the processor 304 provides output based on the geographic coordinate. The geographic coordinate generator 302 provides the output, which, in some implementations, may be provided to a part of the geographic coordinate generator 302 itself, to another application (e.g. to another component of an e-commerce platform), to the merchant device 320, and/or to the user device 330. In some implementations, the output may be a web content, which may be provided to the user interface 338 of user device 330. However, this is only an example. Other outputs are described herein.

In one example, the geographic coordinate generator 302 may provide the output as web content providing visualization of the location of a package being shipped, such as the visualization shown on the user interface 338 of user device 330 in FIG. 8. Here, the precise location of the package being shipped, i.e. the latitude/longitude coordinate (25.774, −80.193) that may be generated at step 1006, is marked by the indicator 702 on map 700, which displays the area nearby the seaport of Miami, where it has been determined that the package may be located.

In some embodiments, the information associated with the shipping of the package includes an indication of one or more prior locations of the package, and the geographic coordinate is generated using the location of the package as indicated in the response from the computing interface and the indication of the one or more prior locations of the package. For example, the information associated with the package having tracking ID “7314131105069” in the shipping record 309 of FIG. 5 may include indications of the prior locations of the package, such as “Venezuela” and “Rio de Janeiro”, stored in the shipping record in the memory 308 of the geographic coordinate generator 302. The latitude/longitude coordinate (25.774, −80.193) is generated based on the location “Florida” returned to the geographic coordinate generator 302 by the carrier API 340 after the call to the carrier API has been made at step 1006 and the information indicating that the package has been shipped to Florida from South America.

In some embodiments, the information associated with the shipping of the package further includes an indication of a time at which the package was present at one of the one or more prior locations, and the geographic coordinate is also generated using the indication of the time. For example, the shipping record 309 of FIG. 5 for the package having tracking ID “7314131105069” includes an indication that the package was in transit in Venezuela at 2:33 PM on October 12 and arrived at customs in Florida at 11:41 AM on October 28. Therefore, just under 16 days have elapsed between the two events, and, based on that information, it may be inferred that the package was shipped by boat. As a result, the geographic coordinate generator 302 may generate the precise location of the package upon its arrival in Florida using this knowledge. For instance, through the use of the geographic coordinate model 311 of FIG. 6, the geographic coordinate generator 302 may determine that the package is at one of three customs depots in Miami near the seaport having an average latitude/longitude coordinate of (25.774, −80.193).

In some embodiments, the information associated with the shipping of the package includes at least one of: a carrier, a service class, one or more prior locations of the package, a date/time stamp associated with a prior location of the package, an estimated next location of the package, a method of transportation of the package, or a known location of a waypoint. Any one or more of the types of information described herein may be the information used, in part, by the geographic coordinate generator 302 to determine the geographic coordinate of the package being shipped. However, this list is not limiting. In one example, the package having tracking ID “7314131105069” in shipping record 309 of FIG. 5 may have the carrier, “Carrier A”, as information associated with the shipping of the package. The service class, “Expedited Shipping” may also or instead be used as information associated with the shipping of the package. As well, the prior locations “Rio de Janeiro” and/or “Venezuela” and/or the current location “Florida” found in the shipping record 309 may be used as information associated with the shipping of the package to be used, in part, to generate the geographic coordinate for the package.

In some embodiments, the generating the geographic coordinate in step 1006 includes calculating an estimated location of the package based on: the location of the package as indicated in the response from the computing interface; an amount of time that has elapsed since the package has left the location of the package as indicated in the response from the computing interface; and an expected travel time between the location of the package as indicated in the response from the computing interface and an estimated next location of the package. For example, in implementing this, the geographic coordinate generator 302 may calculate a precise location of the package using information in the shipping record 309, such as the current and one or more previous locations of the package indicated by the carrier API 340, and possibly the time of transit between each of these locations. The next expected location and the expected time until arrival at the next expected location may be based on prior knowledge from completed shipping records that may be stored in the geographic coordinate model 311 in the memory 308.

For example, it may be known based on the geographic coordinate model 311 that packages travelling from Miami to New York travel via a depot in Atlanta. If a call is made by the geographic coordinate generator 302 to a carrier API 340 and it returns a current location of “Florida”, the geographic coordinate generator 302 may be able to determine a precise location based on the amount of time elapsed between the call to the carrier API and the last shipping event, e.g., departing customs in Miami. The precise location may be determined based on the amount of time that the package has been in transit from a known geographic location, i.e. Miami, en route to the next estimated location, i.e. Atlanta. The geographic location may be calculated as a distance corresponding to the percentage of the expected time for the package to be transported between Miami and Atlanta. The expected travel time may be known from the geographic coordinate model 311 and/or the past shipping records 309 stored in the memory 308.

In some implementations, the expected travel time between the location of the package as indicated in the response from the computing interface and the estimated next location of the package is based on a service class of the package. For instance, a package being shipped having a service class of “expedited shipping” may be prioritized over a package being shipped having a service class of “normal shipping” traveling along the same shipping route and may arrive at a waypoint sooner. As an example, a package having an “expedited shipping” service class may travel by airplane to a particular waypoint, and may arrive at the waypoint before a package having an “normal shipping” service class that may travel to the waypoint by boat.

In some embodiments, the geographic coordinate represents a centroid of latitude and longitude coordinates of two or more known locations. The two or more known locations may each be determined using: (i) the location of the package as indicated in the response from the computing interface, and (ii) the information associated with the shipping of the package. The geographic coordinate generator 302 may generate a geographic coordinate based on more than one possible location of a particular waypoint, which may be included as part of the geographic coordinate model 311 stored in the memory 308.

For example, (i) the carrier API 340 returns the location “Florida” and the most recent shipping event “Arrive Customs” to the geographic coordinate generator 302, and (ii) information associated with the shipping of the package is also obtained, such as previous locations and time elapsed between shipping events. This may indicate that the package being shipped is likely located at a customs depot near the Miami seaport. However, for a particular carrier, Carrier A, there are three possible custom depot locations respectively located at the latitude/longitude coordinates: (25.783, −80.190), (25.768, −80.190), and (25.772, −80.200) where the package may be located. The centroid location may be derived from those three coordinates, such as the centroid of (25.774, −80.193) in the first row of the geographic coordinate model 311 of FIG. 6.

In some embodiments, the centroid is a weighted average of the latitude and longitude coordinates of the two or more known locations. A weighting may be determined based on a likelihood that the package is located at a particular one of the two or more known locations. The two or more known locations are each a location of a respective different waypoint. For example, the centroid coordinate (25.774, −80.193) is used to provide a precise location of the package being shipped when transported from Venezuela to a customs depot in Florida as shown in the geographic coordinate model 311 in FIG. 6. The centroid is calculated by determining the average location of three known customs depots at the latitude/longitude coordinates: (25.783, −80.190), (25.768, −80.190), and (25.772, −80.200). Here, the weighting for each of the locations is equal, as the past shipping records 309 in the memory 308 may not indicate that Carrier A is more likely to send a package having a weight under 10 pounds to one of the particular customs depots over any of the other customs depots. Alternatively, if it is known that a package exceeding 30 pounds is sent to the custom depot located at the latitude/longitude coordinate of (25.783, −80.190) 90% of the time, the weighting will reflect this and the subsequently calculated centroid may instead be (25.782, −80.191).

In some embodiments, the output provided at step 1008 is web content. The web content is implementation specific and could be as simple as an indication of the geographic coordinate itself or an indication that is based on the geographic coordinate (e.g. a message saying “Your package is en route in north-western Florida”). Although not necessary, in some embodiments the web content may include instructions to present a visualization on a display of a user device. The visualization may include a map with a visual indication at or around the geographic coordinate. For example, FIGS. 8 to 10 provide example outputs as web content, shown on the user interface 338 of the user device 330. In FIG. 8, a map 700 is displayed on the user interface 338 that shows the general area near the geographic coordinate generated at step 1006. Here, the area is part of Miami, Fla. near the ocean. The map 700 includes an indicator 702, which encircles the area around the generated geographic coordinate, which is a centroid calculated from more than one possible known location, to indicate that this is the area where the package having a tracking ID of “7314131105069” is located. In another example, FIG. 11 includes a map 900 including part of the New York City seaport and the surrounding area. The map 900 also includes an indicator 902, which directly points to a particular known location indicative of the geographic coordinate.

In some embodiments, the geographic coordinate is used for at least one of: displaying the location of the package on a map, updating a tracking model (e.g. adaptively training a machine learning model used for package tracking), predicting a shipping delay, updating an estimated time of arrival of the package, or estimating carbon emissions associated with the package. The geographic coordinate generator 302 may use the geographic coordinate generated at step 1006 in any one or more of the above-noted ways, however this is not limiting. In one example, the location of a package being shipped may be displayed on a user interface 338 of a user device 330, as shown by indicators 702, 802, and 902 on maps 700, 800, and 900 respectively of FIGS. 8 to 11. The location is based on the geographic coordinate and is more precise than the location returned from the carrier's API 340. As another example, the geographic coordinate may be used to update a model, possibly even the geographic coordinate model 311 itself.

In some embodiments, the geographic coordinate is generated at step 1006 using a model that incorporates the information associated with the shipping of the package. In some such embodiments, the method 1000 may further include: receiving, from a tracking unit, an indication of a geographic coordinate (e.g. latitude and longitude coordinate) associated with a waypoint; and updating the model based on the geographic coordinate associated with the waypoint. For example, the model may be the geographic coordinate model 311 stored in the memory 308 of the geographic coordinate generator 302. The geographic coordinate model 311 incorporates information associated with shipping the package, e.g. carrier and/or weight of the package, etc. If, for example, a GPS chip was placed in a package being shipped from London, UK to Pittsburgh, Pa., USA, the latitude/longitude coordinates of the waypoints may be determined using the data from the GPS chip. This data provides precise, known locations of the waypoint, which may be used to update the precise locations within the geographic coordinate model 311. If the geographic coordinate model 311 is a machine learning model, then such data may be used to train (or retrain/update) the machine learning model.

In some embodiments, a system is provided for performing the methods described above. The system may include a memory (e.g. memory 308) to store information such as a tracking identifier of a package being shipped and information associated with the shipping of the package. The information associated with the shipping of the package may be incorporated into a geographic coordinate model 311 and/or be from a shipping record 309. The system may further include at least one processor (e.g. processor 304) to perform operations such as: instructing transmission of the tracking identifier to the computing interface (e.g. API) provided by the carrier (e.g. by instructing the network interface 306 to transmit the tracking identifier); receiving a response indicating a location of the package; generating a geographic coordinate based on the location indicated in the response and the information associated with the shipping of the package; and providing output based on the geographic coordinate.

In some embodiments, a computer-readable medium is provided having stored thereon computer-executable instructions that, when executed by a computer, cause the computer to perform method steps described above.

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations may be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions, and alterations may be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor-readable storage medium or media for storage of information, such as computer/processor-readable instructions, data structures, program modules, and/or other data. A non-exhaustive list of examples of non-transitory computer/processor-readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor-readable storage media.

What is claimed is:

1. A computer-implemented method comprising:
receiving, from at least one tracking unit placed on at least one object, an indication of a latitude and longitude coordinate associated with a waypoint;
updating a geographic coordinate model based on the latitude and longitude coordinate associated with the waypoint;
transmitting, to a computer-based tracking system via a network using an application programming interface (API), a tracking identifier associated with a particular object in transit;
receiving, from the computer-based tracking system via the network, a response indicating a location of the particular object, the location indicated in the response from the API covering a geographic area;
determining an estimated geographic coordinate associated with the location of the particular object, the estimated geographic coordinate more precise than the geographic area, and the geographic coordinate based on:
the location of the particular object as indicated in the response from the API,
an amount of time that has elapsed since the particular object has left the location of the particular object as indicated in the response from the API, and
an expected travel time between the location of the particular object as indicated in the response from the API and an estimated next location of the particular object,
wherein the estimated geographic coordinate is determined using the updated geographic coordinate model; and
providing output based on the estimated geographic coordinate to a computer device via the network.

2. The computer-implemented method of claim 1, wherein the estimated geographic coordinate is generated based on the location of the particular object as indicated in the response from the API and an indication of one or more prior locations of the particular object.

3. The computer-implemented method of claim 2, wherein the estimated geographic coordinate is also generated based on an indication of a time at which the particular object was present at one of the one or more prior locations.

4. The computer-implemented method of claim 1, wherein the estimated geographic coordinate is also generated based on one or more of: an estimated next location of the object, a method of transportation of the particular object, or a known location of a waypoint.

5. The computer-implemented method of claim 1, wherein the estimated geographic coordinate represents a centroid of latitude and longitude coordinates of two or more known locations.

6. The computer-implemented method of claim 5, wherein the centroid is a weighted average of the latitude and longitude coordinates of the two or more known locations, a weighting being determined based on a likelihood that the particular object is located at a particular one of the two or more known locations, and wherein the two or more known locations are each a location of a respective different waypoint.

7. The computer-implemented method of claim 1, wherein the output is web content, and wherein the web content comprises instructions to present a visualization on a display of the computer device, the visualization including a map with a visual indication at or around the estimated geographic coordinate.

8. The computer-implemented method of claim 1, wherein the estimated geographic coordinate is used for at least one of: displaying the location of the particular object on a map, updating a tracking model, predicting a transit delay, updating an estimated time of arrival of the particular object, or estimating carbon emissions associated with the particular object.

9. The computer-implemented method of claim 1, wherein:
the geographic coordinate model is a machine learning model, and
updating the geographic coordinate model comprises training or retraining the machine learning model based on the estimated geographic coordinate.

10. A system comprising:
one or more processors; and
one or more memories storing instructions that, when executed by the one or more processors, cause:
receiving, from at least one tracking unit placed on at least one object, an indication of a latitude and longitude coordinate associated with a waypoint;
updating a geographic coordinate model based on the latitude and longitude coordinate associated with the waypoint;
transmitting, to a computer-based tracking system via a network using an application programming interface (API), a tracking identifier associated with a particular object in transit;
receiving, from the computer-based tracking system via the network, a response indicating a location of the particular object, the location indicated in the response from the API covering a geographic area;
determining an estimated geographic coordinate associated with the location of the particular object, the estimated geographic coordinate more precise than the geographic area, and the geographic coordinate based on:
the location of the particular object as indicated in the response from the API,
an amount of time that has elapsed since the particular object has left the location of the particular object as indicated in the response from the API, and
an expected travel time between the location of the particular object as indicated in the response from the API and an estimated next location of the particular object,
wherein the estimated geographic coordinate is determined using the updated geographic coordinate model; and
providing output based on the estimated geographic coordinate to a computer device via the network.

11. The system of claim 10, wherein the estimated geographic coordinate is generated based on the location of the particular object as indicated in the response from the API and an indication of one or more prior locations of the particular object.

12. The system of claim 11, wherein the estimated geographic coordinate is also generated based on an indication of a time at which the particular object was present at one of the one or more prior locations.

13. The system of claim 10, wherein the estimated geographic coordinate is also generated based on one or more of: an estimated next location of the object, a method of transportation of the particular object, or a known location of a waypoint.

14. The system of claim 10, wherein the estimated geographic coordinate represents a centroid of latitude and longitude coordinates of two or more known locations.

15. The system of claim 14, wherein the centroid is a weighted average of the latitude and longitude coordinates of the two or more known locations, a weighting being determined based on a likelihood that the particular object is located at a particular one of the two or more known locations, and wherein the two or more known locations are each a location of a respective different waypoint.

16. The system of claim 10, wherein the output is web content, and wherein the web content comprises instructions to present a visualization on a display of the computer device, the visualization including a map with a visual indication at or around the estimated geographic coordinate.

17. The system of claim 10, wherein the estimated geographic coordinate is used for at least one of: displaying the location of the particular object on a map, updating a tracking model, predicting a transit delay, updating an estimated time of arrival of the particular object, or estimating carbon emissions associated with the particular object.

18. The system of claim 10, wherein the geographic coordinate model is a machine learning model, wherein the instructions further cause training or retraining the machine learning model based on the estimated geographic coordinate.

19. One or more non-transitory computer-readable media storing instructions which, when executed by one or more processors, cause:
receiving, from at least one tracking unit placed on at least one object, an indication of a latitude and longitude coordinate associated with a waypoint;
updating a geographic coordinate model based on the latitude and longitude coordinate associated with the waypoint;
transmitting, to a computer-based tracking system via a network using an application programming interface (API), a tracking identifier associated with a particular object in transit;
receiving, from the computer-based tracking system via the network, a response indicating a location of the particular object, the location indicated in the response from the API covering a geographic area;
determining an estimated geographic coordinate associated with the location of the particular object, the estimated geographic coordinate more precise than the geographic area, and the geographic coordinate based on:
the location of the particular object as indicated in the response from the API,
an amount of time that has elapsed since the particular object has left the location of the particular object as indicated in the response from the API, and
an expected travel time between the location of the particular object as indicated in the response from the API and an estimated next location of the particular object,
wherein the estimated geographic coordinate is determined using the updated geographic coordinate model; and
providing output based on the estimated geographic coordinate to a computer device via the network.

20. The one or more non-transitory computer-readable media of claim 19, wherein the geographic coordinate model is a machine learning model, wherein the instructions further cause training or retraining the machine learning model based on the estimated geographic coordinate.
